(19) United States
(12) Patent Application Publication
(10) Pub. No.: US 2005/0160845 A1
(43) Pub. Date: Jul. 28, 2005

(54) Mass retentive linear impeller

(76) Inventor: Allen Keefe, St. Matthews, SC (US)

Correspondence Address: Richard C. Litman;LITMAN LAW OFFICES, LTD., P.O. Box 15035, Arlington, VA, 22215, US

(21) Appl. No.: 10/752,004

(22) Filed: Jan. 7, 2004

Related U.S. Application Data
(60) Provisional application No. 60/442,908, filed on Jan. 28, 2003.

(51) Int. Cl. F16H 27/04

(52) U.S. Cl. 74/84 S

(57) ABSTRACT

A mass retentive linear impeller is used to convert rotational energy into directional, linear energy. The mass retentive linear impeller comprises a plurality of tracks with a plurality of torque carriages located on the tracks. The torque carriages further comprise two counter rotating flywheels, which are located on a framework. Two rotating arms are located inside of the flywheel and are attached to a center motor of the flywheel, which act as a central axis for the rotating arms. A weight is located at the distal end of each rotating arm. The rotating arms induce a centrifugal force, which creates a temporary pull in one direction. This produces a sequence of forward and backward thrusts.

### CROSS-REFERENCE TO RELATED APPLICATION

This application claims the benefit of U.S. Provisional Patent Application Ser. No. 60/442,908, filed Jan. 28, 2003.

### BACKGROUND OF THE INVENTION

1. Field of the Invention

The present invention relates to propulsion devices, and more particularly to a mass retentive linear impeller for converting rotational energy into a linear motion for thrust.

2. Description of Related Art

Propulsion devices of many kinds are commonly used in many different applications. Propulsion devices such as motors are used every day in automobiles. High velocity propulsion devices such as rockets are used in airplanes, missiles and spacecraft. When a car moves, its motor uses fuel to turn the wheels that act against the road, with the reaction resulting in forward motion. When a rocket moves it expels accelerated mass in the direction opposite to its forward motion. The mass expelled by the rocket is fuel and a rocket uses a large amount of fuel.

Problems exist with the existing high velocity rocket propulsion devices. Rockets expel a great deal of fire and therefore are not fuel efficient propulsion devices. Rockets also are not safe due to the dangerous downdraft of the rocket fire. Rockets also require a great deal of maintenance. To reduce these problems propulsion devices exist that convert rotational energy into linear thrust. These devices induce motion while retaining all structural mass, without reacting directly with outside mass. Rotational energy propulsion devices that are representative of the existing industry are disclosed in the following patent documents.

U.S. Pat. No. 4,884,465 to Zachystal discloses a device for obtaining a directional force from rotary motion. The device uses a frame that is rotated about a longitudinal axis at a selected annular speed. A weight is connected to the frame and rotates about a transverse axis at the same angular speed. When the weight has traversed 180°, the frame itself will have rotated 180°, so that the weight will return to its original position on the same side of the apparatus as it traversed in the first half cycle. The resultant centrifugal forces all act to one side of the apparatus, producing a unidirectional force.

U.S. Pat. No. 6,259,177 to Deschamplain discloses a motion imparting system for converting rotational motion into linear motion using a centrifuge. The centrifuge comprises a chamber that is partially filled with water. A motor imparts a rotary motion about a major axis to the centrifuge and moves the water outwardly under the influence of centrifugal forces. An object has its exterior end positioned within the fluid during rotation of the centrifuge and its interior end positioned exterior of the fluid in the air during the rotation of the centrifuge. A rod has an axis parallel with, but laterally offset from, the axis of the centrifuge. A driver rotates the rod at the same speed as the centrifuge. A connector couples the object and the rod whereby when the rod and centrifuge are rotated simultaneously during operation and use, the rotational forces within the system will be converted to a linear force.

United Kingdom Pat. No. 2 078 351 to Cook discloses a device for the conversion of centrifugal force to linear force. The device comprises a pair of arms that counter-rotate about a common axis. One arm carries a pair of weights, one of which is transferable to the other arm at 180-degree intervals where the arms pass each other at two separate points. As a result the centrifugal force is converted to a linear force that will move the device in a given direction. Two of the devices may be used together to create a steadier force in the desired direction.

U.S. Pat. No. 5,090,260 to Delroy discloses a gyrostat propulsion system. The system is a thrust producing apparatus comprising a gyrostat having a gyrostat wheel, an apparatus for supporting the gyrostat, an apparatus for toppling the gyrostat creating a precessional force in a predetermined direction against the supporting apparatus, and an apparatus for rotating the gyrostat into an orientation whereby it can again be toppled while avoiding the creation of precessional force in a direction opposite to the predetermined direction. Controlled unidirectional movement of the apparatus based on gyrostatic precession is thereby obtained.

United Kingdom Pat. No. 2 090 404 to Russell discloses a gyroscopic propulsion system. The system comprises a series of hollow spheres rotatably mounted one within the other. A series of three equi-angularly spaced gyroscopes are located in a vertical plane around the inner surface of the inner sphere that is rotated about a horizontal axis. The gimbals of the gyroscope can be locked in sequence to produce gyroscopic precessional torque impulses for driving a craft in which the system is located in horizontal directions. A further series of gyroscopes are located at equi-angularly spaced locations in an annular chamber fixed externally to the inner sphere.

United Kingdom Pat. No. 2 207 753 to Morgan discloses a force generating apparatus. The apparatus for generating directional force utilizes gyroscopic effects. The apparatus includes a center rotor, which carries a plurality of outer rotors that travel in a circular path around the center axis. Each of the outer rotors is carried in a gimbal yoke so that the axes of the outer rotors lie in a respective plane radial the axis of the center rotor. The yoke is selectively rotatable with respect to the center rotor to alter the angle of the outer rotor axes in unison. This rotation of the yokes provides a resultant force acting directionally on the assembly.

None of the above inventions and patents, taken either singly or in combination, is seen to describe the instant invention as claimed.

### SUMMARY OF THE INVENTION

The present invention is a propulsion device for converting rotational energy into directional, linear-energy induced motion. The mass retentive linear impeller of the present invention is used to convert rotational energy into linear thrust for a variety of travel vehicles including, but not limited to, airplanes, spacecraft, seacraft or land vehicles. The mass retentive linear impeller comprises a system of tracks, torque carriages and actuator assemblies. The torque carriages are slidably attached to the tracks. The number of torque carriages used is dependent on the desired amount of linear thrust.

The torque carriage comprises a framework, a pair of sliding track attachment means, a carriage pawl and at least two counter-rotating flywheels. The track attachment means slidably attach the framework of the carriage to the tracks and allow for the carriage to slide along the length of the track. The track attachment means are each located at opposite ends of the framework. The carriage pawl is attached to the framework and releasably engages a set of ratchet teeth that are located along the interior surface of each of the tracks.

Each of the flywheels comprises a center motor, a pair of rotating arms and a pair of weights. The rotating arms are attached to the center motor, which powers the rotating arms and serves as a central axis point for their rotation. The weights are located at the distal end of each of the rotating arms. The two flywheels are connected to the framework and rotate in opposite directions.

The actuator assembly comprises a directional actuator, a resistance rod, a pawl lever, the carriage pawl and an actuator pawl. The pawl lever is attached to the carriage pawl. The resistance rod is located between the pawl lever and the directional actuator. The actuator pawl is attached to the directional actuator at one end and the other end releasably engages the ratchet teeth on the tracks.

The weighted rotating arms inside of the two flywheels rotate to create rotary energy. When an eccentric weight is rotated in this manner, it pulls continuously away from the center. The weights at the end of the rotating arms pull away from the center motor as they rotate around the axis. This force can be used to pull a vehicle in the forward direction if all other counter forces are neutralized. The two counter forces that need to be neutralized are the backward force and the side-to-side motion. The side-to-side motion is neutralized by having two counter-rotating flywheels. The rotating arms in each of the two flywheels rotate in opposite direction, thus negating the side-to-side effects.

To counter the backward force created by the rotating arms, the carriage is allowed to slide back along the tracks, instead of pushing the vehicle backwards. A series of ratchet teeth are located on the interior surface of the tracks. The carriage pawl engages the ratchet teeth. When the weighted rotating arms are swinging in the desired forward direction, the carriage pawl locks into place so that the forward thrust pushes the entire vehicle forward. When the weighted rotating arm is swinging in the opposite direction, the carriage pawl releases from the ratchet teeth and allows the carriage to slide backward to the next ratchet tooth. The forward thrusting and backward sliding cycle continues until the carriage reaches the end of the track. At this point the carriage must return to the front of the track to continue its cycle. This is done by disengaging the carriage ratchet and the actuator ratchet and splitting the weighted rotating arms in half to balance out in each of the flywheels. The carriage then slides to the front of the track and the ratchets are re-engaged. The weighted rotating arms come back together to form the pull weight and continue to rotate together.

Accordingly, it is a principal object of the invention to provide a mass retentive linear impeller that can convert rotational energy into linear directional energy.

It is another object of the invention to provide a mass retentive linear impeller that is capable of complete directional reversal while operating at full power.

It is a further object of the invention to provide a mass retentive linear impeller that is safer than, and requires less maintenance than conventional propulsion devices.

Still another object of the invention is to provide a mass retentive linear impeller that is more fuel-efficient than conventional propulsion devices.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a mass retentive linear impeller according to the present invention.

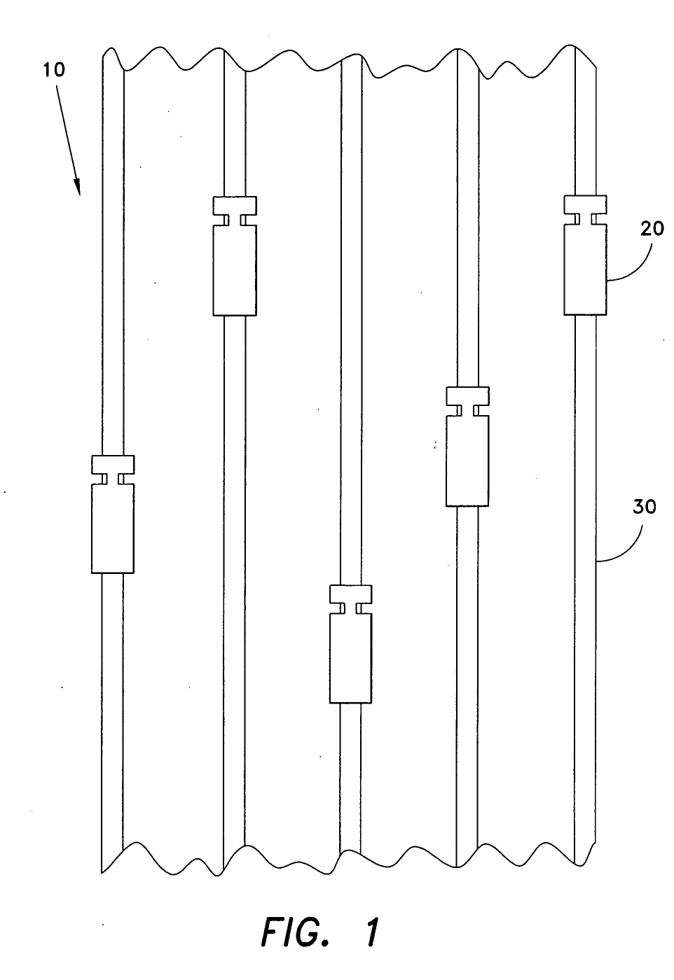

FIG. 2 is an interior view of a torque carriage according to the present invention.

FIG. 3A is a perspective view of a rotating flywheel with the rotational energy converted into forward linear energy.

FIG. 3B is a perspective view of a rotating flywheel with the rotational energy converted into reverse linear energy.

FIG. 3C is a perspective view of a rotating flywheel with the swinging arms in a locked, balanced position.

Similar reference characters denote corresponding features consistently throughout the attached drawings.

### DETAILED DESCRIPTION OF THE PREFERRED EMBODIMENTS

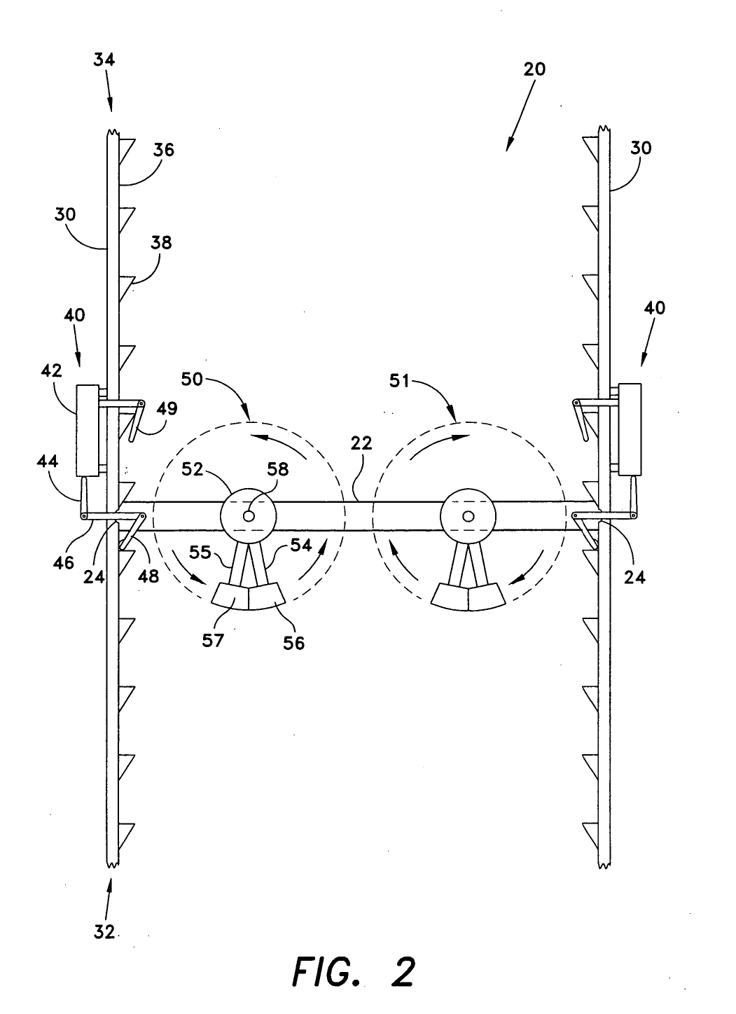

The present invention is a propulsion device that converts rotational energy into directional, linear energy induced motion. The propulsion device is a mass retentive linear impeller 10 that is used to covert rotational energy into linear thrust for a variety of travel vehicles including, but not limited to, airplanes, spacecraft, seacraft or land vehicles. The mass retentive linear impeller 10 comprises a system of tracks 30, with a plurality of torque carriages 20 and a plurality of actuator assemblies 40 (depicted in FIG. 2). The plurality of torque carriages 20 are slidably attached to the system of tracks 30. The number of torque carriages 20 used is dependent on the desired amount of linear thrust.

FIG. 2 depicts an interior view of a torque carriage 20. All of the individual torque carriages 20 are configured in the same manner so discussion of only one torque carriage 20 is required. The torque carriage 20 comprises a framework 22, a pair of counter-rotating flywheels 50 and 51, a carriage pawl 48 and a pair of sliding track attachment means 24. The framework 22 extends across the space between the two tracks 30. A track attachment means 24 is located at each end of the framework 22. The track attachment means 24 slidably secure the framework 22 to the tracks 30. The track attachment means 24 allow the framework 22 to slide along the length of the tracks 30.

The two counter-rotating flywheels 50 and 51 are located on the framework 22. The flywheels 50 and 51 further comprise a center motor 52 and two swinging arms 54 and 55 with a pair of weights 56 and 57 located at the ends of each swinging arm 54 and 55. The swinging arms 54 and 55 are powered by the center motor 52 and rotate around a central axis 58. A first end of the carriage pawl 48 is attached to the framework 22. The second end of the carriage pawl 48 releasably engages a set of ratchet teeth 38 located on the inner surface 36 of the tracks 30. The ratchet teeth 38 are located along the entire length of the tracks 30 from a front end 32 to a back end 34.

The actuator assembly 40 further comprises a directional actuator 42, a resistance rod 44, a pawl lever 46, the carriage pawl 48 and an actuator pawl 49. The pawl lever 46 attaches to the carriage pawl 48 to the actuator assembly 40. The resistance rod 44 is located between the pawl lever 46 and the directional actuator 42. The actuator pawl 49 is attached to the directional actuator 42 at one end and the other end releasably engages the ratchet teeth 38 on the tracks 30.

The center motor 52 supplies power to the swinging arms 54 and 55, causing them to rotate about the center axis 58. While rotating, the swinging arms 54 and 55 remain together. This results in an unbalanced weight rotating inside of the flywheels 50 and 51 due to the weights 56 and 57 located at the ends of the swinging arms 54 and 55. When an off balance weight is rotated in this manner, it pulls continuously away from the center. The weights 56 and 57 at the end of the rotating arms 54 and 55 pull away from the center motor 52 as they rotate around the center axis 58.

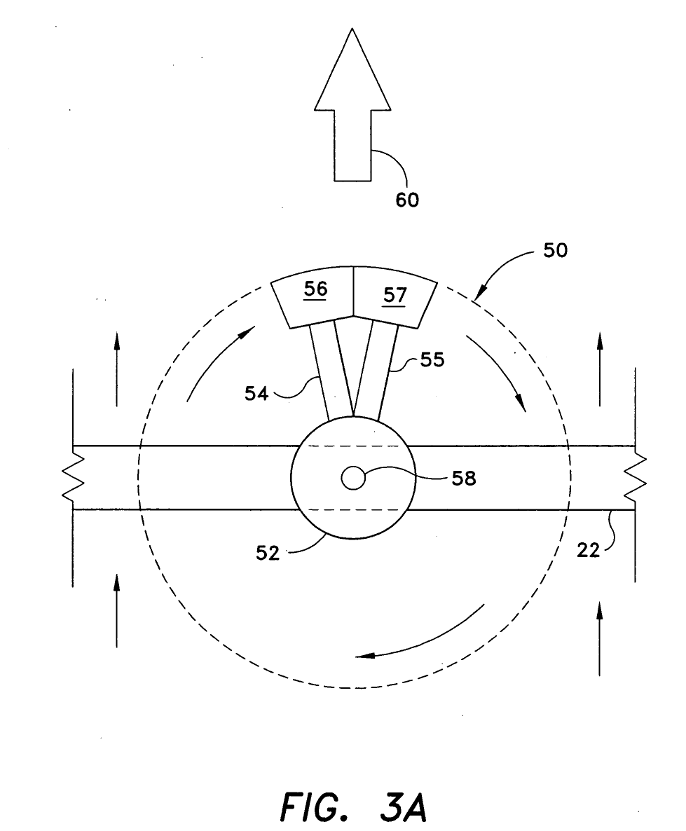

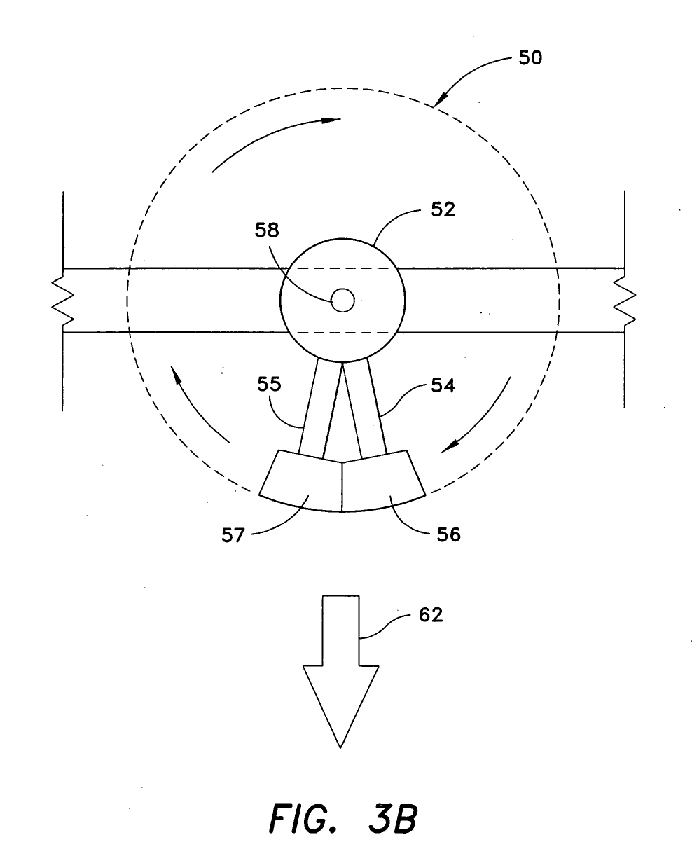

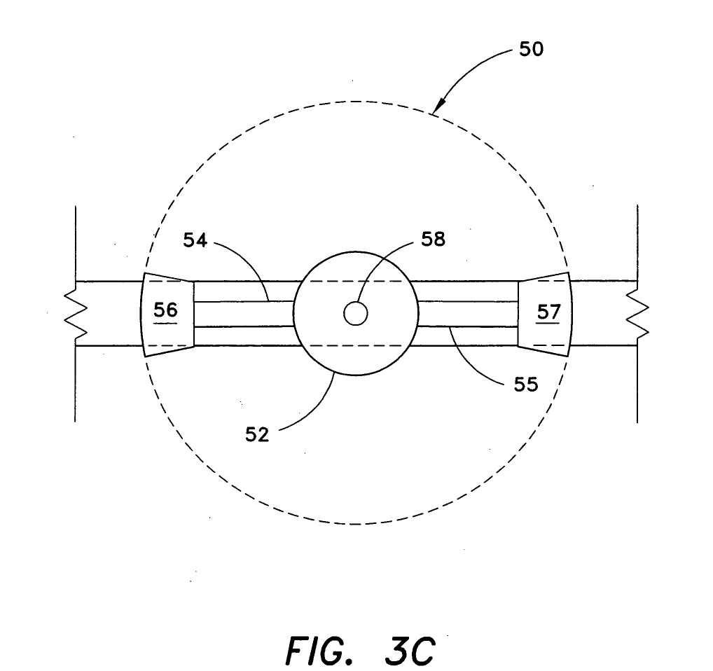

FIG. 3A further depicts a single flywheel 50. When the rotating arms 54 and 55 reach the front of the flywheel 50 a forward force is generated. The arrow 60 depicts this force. This force can be used to pull a vehicle in the forward direction if all other counter forces are neutralized. The two counter forces that need to be neutralized are the backward force and the side-to-side motion. FIG. 3B depicts the backward force, depicted by the arrow 62, that is generated when the rotating arms 54 and 55 reach the back end of the flywheel 50.

Side to side motion is created by the rotating weights 56 and 57 generating an outward force while they swing past the side of the flywheels 50 and 51. To neutralize the effects of this side-to-side motion two counter-rotating flywheels 50 and 51 are used simultaneously. When the two sets of rotating weights inside each of the flywheels 50 and 51 rotate in opposite directions they create opposing side-to-side forces. For example, when the one flywheel 50 creates a force in a westward direction, the counter-rotating flywheel 51 creates an opposite and equal force in an eastward direction. Because the two forces are equal, their effects on the carriage 20 are neutralized.

In order to provide a forward thrust for the vehicle the forward linear energy must be used and the backward linear energy must be neutralized. When the rotating arms 54 and 55 reach the front end of the flywheels 50 and 51 the carriage pawl 48 is releasably engaged to the ratchet teeth 38. While the carriage pawl 48 is releasably engaged to the ratchet teeth 38 the framework 22 cannot move. This allows all of the rotating energy created by the flywheels 50 and 51 to be converted to forward thrust for the vehicle. Therefore, the forward thrust will pull the vehicle forward.

When the rotating arms 54 and 55 reach the back end of the flywheels 50 and 51 the carriage pawl 48 releases from the ratchet teeth and allows the framework 22 to slide backward along the tracks 30. Once the framework 22 has slid the carriage pawl 48 engages the next tooth on the set of ratchet teeth 38. The carriage 20 is slid back by the directional actuator 42 that pulls the framework 22 backward along the track 30. Because the backward linear energy is used to pull the framework 22 backward along the track, it does not create a backward thrust to pull back the motion of the vehicle. The sliding back of the torque carriage 20 neutralizes the backward effect of the linear energy against the vehicle.

When the torque carriage 20 moves backward to the next ratchet tooth 38 the carriage 20 tends to move backward without inducing a great deal of forward momentum, unless it is restrained. The actuator assembly 40 provides a means for restraining the carriage 20 without transmitting any reverse force on the vehicle.

The reverse force is counteracted by pulling forward on the resistance rod 44. When the carriage pawl 48 is pushed down the pawl lever 46 is turned, which pulls the resistance rod 44. The resistance rod 44 is attached to the directional actuator 42. Because the directional actuator 42 is locked in place on the track 30 buy the actuator pawl 49, the forward pull of the resistance rod 44 is transferred to the vehicle and not the carriage 20. The pull of the resistance rod 44 on the vehicle negates the carriage pawl 48 induced reverse thrust.

Once the torque carriage 20 reaches the back end 34 of the track 30 it must return to the front end 32 of the track to continue its sequence. To move the carriage 20 to the front end 32 of the track 30 the carriage pawl 48 and the actuator pawl 49 disengage from the ratchet teeth 38. The weights 56 and 57 split and move to a balanced, locked position as depicted in FIG. 3C. At this time the swinging arms 54 and 55, while continuing to rotate, balance out so no reciprocating (back and forth) energy is generated. The carriage 20 then freely slides to the front end of the track 32, the swing arms 54, 55 and the weights 56, 57 return to their original position, as depicted in FIG. 3A, the carriage pawl 48 and the actuator pawl 49 re-engage the ratchet teeth 38, and the sequence starts over.

It is to be understood that the present invention is not limited to the sole embodiments described above, but encompasses any and all embodiments within the scope of the following claims.

1. A propulsion device comprising:
a system of tracks, each track having a first end and a second end;
a plurality of torque carriages slidably disposed along the tracks; and
a plurality of actuator assemblies;
whereby the torque carriages slide along the tracks and convert rotational energy into directional, linear energy induced motion.

2. The propulsion device according to claim 1, wherein each torque carriage comprises:
a framework having two ends, extending across the space between two of said tracks;
a pair of counter-rotating flywheels disposed along said framework;
a pair of slidable track attachments, each track attachment secured to one of the ends of said framework for securing said torque carriage to the tracks, wherein the track attachments allow the framework to slide along the tracks; and
at least one carriage pawl for locking the torque carriages in certain positions along the tracks.

3. The propulsion device according to claim 2, wherein said flywheels each comprise a center motor defining a center axis of each flywheel, two swinging arms each having a first end secured to the center motor and a second, distal end, and a weight disposed along the distal end of each swinging arm, wherein the center motor powers the swinging arms causing them to rotate about the center axis to create rotational energy.

4. The propulsion device according to claim 3, wherein the swinging arms of a first of said flywheels rotate in a first direction and the swinging arms of a second flywheel rotate in a second direction counter to the swinging arms of the first flywheel to neutralize any side-to-side motion of the torque carriage created by the swinging arms.

5. The propulsion device according to claim 1, further comprising a plurality of ratchet teeth disposed along the entire length of the tracks.

6. The propulsion device according to claim 2, wherein the torque carriage comprises two carriage pawls, one disposed on each end of said framework.

7. The propulsion device according to claim 2, wherein each carriage pawl comprises a first end attached to the framework and a second end releasably engaging the ratchet teeth disposed on the tracks.

8. The propulsion device according to claim 2, further comprising an actuator assembly for pulling the torque carriages backward along the tracks to neutralize the reverse energy created by the swinging arms.

9. The propulsion device according to claim 8, wherein said actuator assembly further comprises a directional actuator, a resistance rod, a pawl lever and an actuator pawl, wherein the pawl lever attaches the carriage pawl to the actuator assembly, the resistance rod is located between the pawl lever and the directional actuator, and the actuator pawl is attached to the directional actuator at a first end and releasably engages the ratchet teeth at a second end.

10. A propulsion device comprising:
a plurality of tracks;
a plurality of torque carriages, each carriage having a frame, a carriage pawl, track attachment means and a plurality of counter rotating fly wheels, wherein each of said counter rotating flywheels comprises a center motor and a plurality of rotating arms, wherein each rotating arm carries a weight at the end of said rotating arm, the carriages being slidably mounted on the tracks;
a plurality of ratchet teeth disposed on said tracks;
an actuator assembly having a directional actuator, a resistance rod, an actuator pawl engaging said ratchet teeth, and a pawl lever; and
a plurality of track attachment slides attached to the tracks.
